(19) United States
(12) Patent Application Publication
(10) Pub. No.: US 2002/0055297 A1
(43) Pub. Date: May 9, 2002

(54) MODULAR FEMALE ELECTRICAL TERMINAL

(76) Inventor: JOHN V. FEENY JR., LIVONIA, MI (US)

Correspondence Address: PAUL WEINSTEIN, PERMAN & GREEN LLP, 425 POST TOAD, FAIRFIELD, CT, 06430

(21) Appl. No.: 09/406,450

(22) Filed: Sep. 27, 1999

(51) Int. Cl. H01R 13/58; H01R 13/187

(52) U.S. Cl. 439/453

(57) ABSTRACT

A modular female electrical terminal includes a receptacle portion for receiving a male electrical terminal. A first module comprises a base member formed of a first material and having a first thickness. The base member preferably provides the principal current flowpath through the female terminal. A second module comprises a cover member which is formed of a second material having a second thickness. The cover member is secured to the base member in an overlying relationship so as to define in cooperation with the base member a cavity suitable for receiving the desired male terminal shape. At least one of the first module or the second module includes means for biasing the male electrical terminal into electrical and frictional contact with the receptacle portion of the terminal. The base member includes side walls extending toward the cover member to define the cavity.

### CROSS REFERENCE TO A RELATED APPLICATION

U.S. patent application Ser. No. 09/124,140 filed Jul. 29, 1998, by Roy et. al., entitled Electrical Receptacle Terminal.

### BACKGROUND OF THE INVENTION

1. Field of the Invention

The present invention relates to a modular female electrical terminal having a receptacle portion for receiving a male electrical terminal and having any desired interface such as a pin or blade.

2. Prior Art

U.S. Pat. No. 5,800,220 to Feeny et al. discloses a typical tab-receptacle terminal with a box shape which is formed by bending a single sheet of electrically conductive material.

U.S. Pat. No. 5,188,545 to Hass et al., as well as the following foreign patent documents: WO 97/49145, WO 89/05531, DE G 85 02 106.7, EP 0 352 871 A2 and DE G 86 08 199.3, illustrate two part receptacle contacts. A good conductive material is used as a base contact to which a cage usually with an overspring element is added and attached to the base through folded flaps. These contacts use a separate cage because good conductive materials may have poor resilient qualities.

U.S. Pat. Nos. 3,370,265 to Berg, 5,217,382 to Sparks, 5,433,629 to Yagi et al. and 5,427,552 to Zielinski et al. are illustrative of receptacle contacts wherein a spring is a separate element.

### SUMMARY OF THE INVENTION

In accordance with a preferred embodiment of the present invention a modular female electrical terminal is provided. The female terminal includes a receptacle portion for receiving a male electrical terminal. The receptacle portion comprises a first module capable of interfacing with a variety of male electrical terminal shapes. The first module comprises a base member. The base member preferably provides the principal current flowpath through the female terminal. This may be accomplished through appropriate selection of the thickness and/or conductivity of the base member.

The female terminal further includes a second module which comprises a cover member. The cover member is secured to the base member in an overlying relationship so as to define in cooperation with the base member a cavity suitable for receiving a desired one of the male terminal shapes. The terminal further comprises means for biasing the male electrical terminal into electrical and frictional contact with the receptacle portion of the terminal.

The base member in accordance with this invention includes at the receptacle portion side walls integral therewith extending toward the cover member so as to form the desired receptacle shape.

Preferably the first material in each of these embodiments is selected to provide a higher conductivity and/or a greater thickness than the second material. In a specific embodiment the first module and the second module are joined by welding although mechanical interlocking can be employed. Preferably the welding process comprises beam welding such as laser welding.

### BRIEF DESCRIPTION OF THE DRAWINGS

The foregoing aspects and other features of the invention are explained in the following description, taken in connection with the accompanying drawings, or in:

FIG. 1 is a perspective view of a female electrical terminal in accordance with one embodiment of this invention.

FIG. 2 is a partial perspective view of the base portion of the female electrical terminal including a separate spring element.

FIG. 3 is a perspective view of a universal base element in accordance with a preferred embodiment of this invention.

FIG. 4 is an exploded view of a female electrical terminal in accordance with this invention utilizing mechanical interlocking between the base element and the cover element.

FIG. 5 is a cross-sectional view of a female electrical terminal in accordance with a preferred embodiment of this invention showing a blade type male terminal inserted therein.

FIG. 6 is a front view of a female terminal in accordance with an alternative embodiment of this invention.

FIG. 7 is a partial perspective view of an ferrule portion of a base element in accordance with a second embodiment to this invention including certain insulation piercing features.

### DETAILED DESCRIPTION OF THE PREFERRED EMBODIMENTS

Although the present invention will be described with reference to the embodiments shown in the drawings it should be understood that the present invention may be embodied in many forms of alternative embodiments. In addition any suitable size, shape or type of materials or elements could be used.

In accordance with this invention a female electrical terminal or contact is provided. When miniaturizing electrical terminals often times the stock thickness of the material of the terminal is compromised or minimized due to the small packaging size allowed. Typical female terminals comprise a receptacle or socket part made of metal sheet folded on itself to create a closed box shape. The formability required for small or intricate areas of such parts makes it much more difficult to form them. This ordinarily results in a large and expensive production tool. In order to meet customer requirements for robustness in electrical performance additional costly features are often added to the part such as hoods or over cages to protect the small interface/contact area. The hoods are good for protecting the interface of the terminal from damage, however they do very little else for performance of the system. The hoods add very little if any electrical value to the design and increase the cost of the contacts over cage. Also the insertion of spring elements during the manufacturing process is difficult.

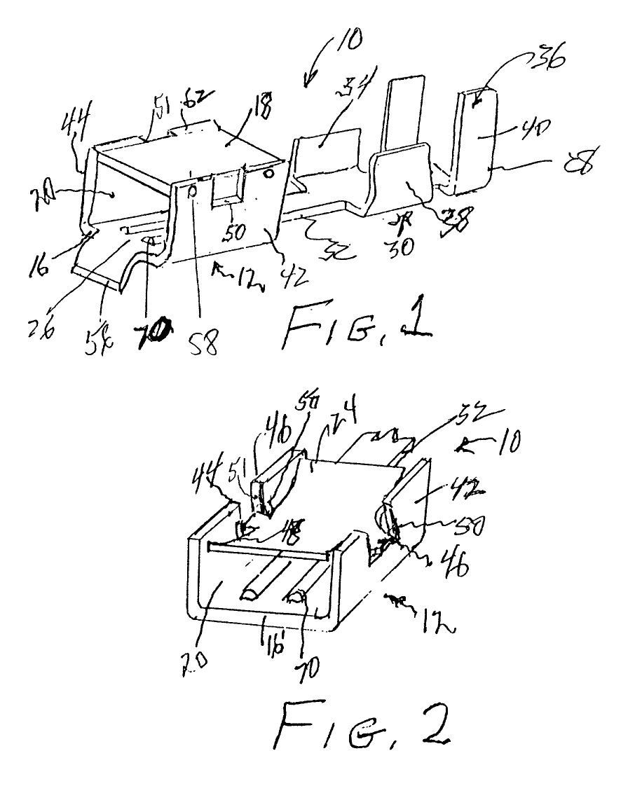

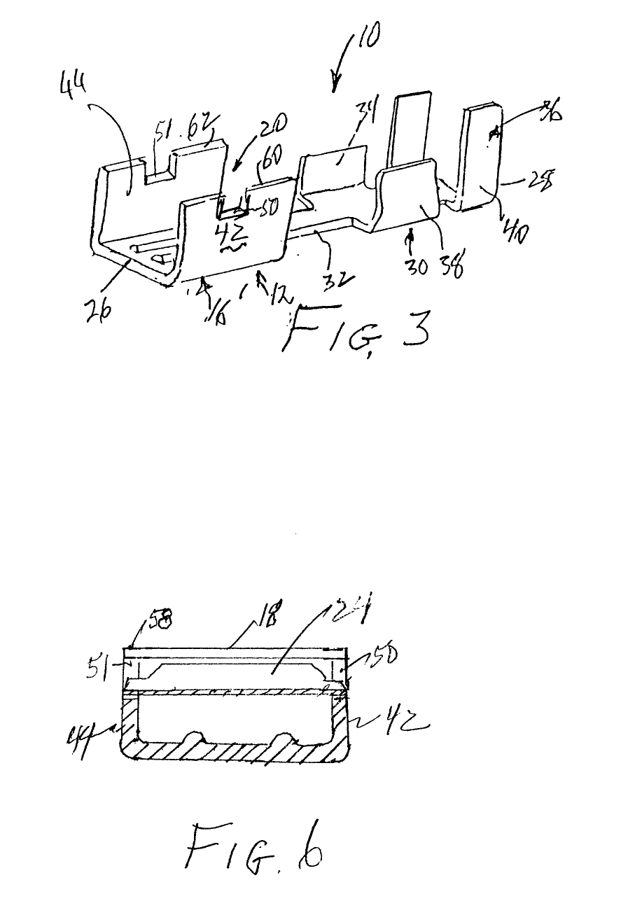

Referring now to FIGS. 1-3 and 6 there is shown a preferred embodiment in accordance with one approach of the invention. A modular female electrical terminal 10 has a receptacle portion 12 for receiving a male electrical terminal such as the blade type contact 14 as shown in FIG. 5. A receptacle portion 12 or interface may have any desired cross-sectional shape adapted to cooperate with any desired male terminal cross-sectional shape, such as for example, pin or blade receiving shapes.

Preferably the receptacle portion 12 comprises a first module 16 which is capable of interfacing with a desired one of a variety of male electrical terminal shapes, such as pin or blade types or other desired shape as are known in the art. The first module 16 comprises a base member of the terminal 10 and is formed of a first material having a first thickness. The base member 16 preferably provides the principal current flowpath through the female terminal 10. This is preferably accomplished by controlling the thickness or conductivity or both the thickness and conductivity of the base member 16. The conductivity of the base member 16 is easily controlled by appropriate selection of the material from which the base member is constructed.

The second module 18 comprises a cover member. The cover member 18 is formed of a second material and has a second thickness. The second thickness may be the same as or different from the first thickness. In a particularly preferred embodiment the second thickness is less than the first thickness, since due to the invention, the base member 16 is the principal current path and the cover member 18 does not need to have high current carrying capabilities. The cover member 18 is secured to the base member 16 in an overlying relationship. The cover member 18 defines in cooperation with the base member 16 a cavity 20 which is suitable for receiving a desired one of the male electrical terminal shapes. At least one of the first module or the second module includes a means 24, as for example, the spring element 24 in FIG. 2, for biasing the male electrical terminal into electrical and frictional contact with the receptacle portion 12.

The female electrical terminal 10 is adapted to be mated with a male contact (not shown) at the front end 26 of the terminal 10. The rear end 28 of the terminal 10 is adapted to connect the terminal 10 to a conductor (not shown). The terminal base member 16 in this embodiment is one-piece member made from sheet metal or other conductive material. The base member 16 has a front receptacle portion 12 and a rear conductor connection portion or ferrule 30. As best seen by reference to FIG. 7, the front receptacle portion 12 is an open shell or cavity 20 adapted to admit a desired male contact 14 therein. In the most preferred embodiment of this invention the cavity 20 of the receptacle portion 12 of the terminal 10 has a generally rectangular box shaped cross-section. In alternate embodiments, the cavity 20 may have any suitable cross-section to admit a desired male contact shape therein.

Referring to FIG. 1 the rear portion of the terminal 28 includes a transition section 32, an intermediate section 34 and a distal section 36. The transition section 32 connects the ferrule 30 to the receptacle portion 12 of the terminal 10. The intermediate section 34 and the distal section 36 of the ferrule have a general “U” shaped channel configuration. The ferrule portion 30 of the terminal 10 is arranged downstream (in the insertion direction) of the receptacle portion 12 and is integrally connected thereto. The intermediate section 34 is adapted to receive a conducting core of a conductor (not shown). The distal section 36 is preferably somewhat wider than the intermediate section 34 in order to admit a portion of the conductor having insulation thereon. Both the intermediate section 34 and the distal section 36 have side compression tabs 38 and 40 respectively. The terminal 10 is connected to the conductor by placing the conductor in the ferrule portion 30 and compressing or crimping the tabs 38 and 40 onto the conductor. These side compression tabs 38 are compressed downward around the conducting core of the conductor to crimp the conducting core to the intermediate section 34. The side compression tabs 40 on the distal section 36 of the ferrule 30 are pressed downward around the insulated portion of the conductor to crimp the insulated portion to the distal section 36 of the terminal 10.

A first advantage of this invention is that it is possible to maximize the material thickness of the terminal 10 in the areas where the material is most needed for electrical and mechanical performance. The female terminal 10 in accordance with a preferred aspect of this invention allows for a more robust design by allowing the material thickness to be maximized in the areas most needed such as the terminal base 16 where the main current path of the system is preferably provided. It is possible in accordance with this invention to add additional material to the base to increase the current flow and still maintain the same miniaturized packaging size of other terminals. Due to the structure of the contact in accordance with this invention, alternatively or in addition to increasing the thickness of the base it is possible to increase the conductivity of the base member 16 as compared to the cover member 18 by proper selection of the material forming the cover member. For example the cover member 18 can be made from a material having high strength and resiliency such as stainless steel or beryllium copper while the base member 16 can be formed from a higher conductivity copper alloy having sufficient strength for use in a terminal. It is a unique aspect of this invention that the materials which form the respective cover member 18 and base member 16 are formed, may be selected to provide any desired combination of strength and conductivity for each of the modules. Since it is possible to use different materials for each module 16 and 18 a variety of combinations are possible to provide a desired female terminal.

In accordance with this invention, the base member 16 includes at the receptacle portion 12, side walls 42 and 44 integral therewith, extending towards the cover member 18 so as to form an open cavity 20 which is shaped to receive a desired male electrical terminal 14 shape or any other desired male terminal shape.

Referring now to FIG. 2 the cover member has been omitted to allow viewing of the underlying spring member 24. The spring member 24 is stamped from sheet metal or other conductive material. It is possible when using a separate spring member 24 to form it of any desired material which exhibits the desired spring properties. It may be formed from the same or a different material than is used for the respective base member 16′ or the cover member 18. For example, it can be formed from a higher strength material which has excellent spring properties such as beryllium copper or any other desired material, irrespective of the material(s) forming the base member 16′ or cover member 18.

The spring 24 preferably has a general leaf-spring type configuration. When viewed from the top plan view, the spring 24 preferably has a substantially rectangular form. Two side tabs 46 project laterally from the longitudinal or curved edges 48 of the spring 24. The side tabs 46 are located generally at the middle or base of the spring 24. The side tabs 46 have an appropriate length and width to be admitted into slots 50 in the side walls 42 and 44 of the receptacle portion 12 when the spring is mounted to the first module or base member 16′. Any desired separate spring member 24 could be employed in accordance with this invention as noted in the patents cited in the background of this invention, which are specifically incorporated by reference herein. Further details of a suitable spring element 24 can also be found in U.S. Application Ser. No. 09/124,140 to Roy et al. cross-referenced herein which is also incorporated by reference herein. The spring element 24 is mounted in the base member 16′ according to the invention.

In summary, FIG. 1 shows the terminal 10 according to a preferred embodiment of the invention. The base member 16 comprises further an intermediate part 32 and a front part 12. The front part 12 has a generally open box shaped cross section with a bottom 26 and side walls 42, 44. According to the first embodiment of the invention the side walls include slot type openings 50, 51 for receiving the spring element 24. As seen in FIG. 2 openings 50 and 51 receive tabs 46 of a spring element 24, such spring element being easily inserted in the openings 50 and 51 due to the structure of the terminal according to the invention. As seen in FIGS. 1 and 4-6, the socket part 12 of the terminal according to the invention is closed by a cover 18.

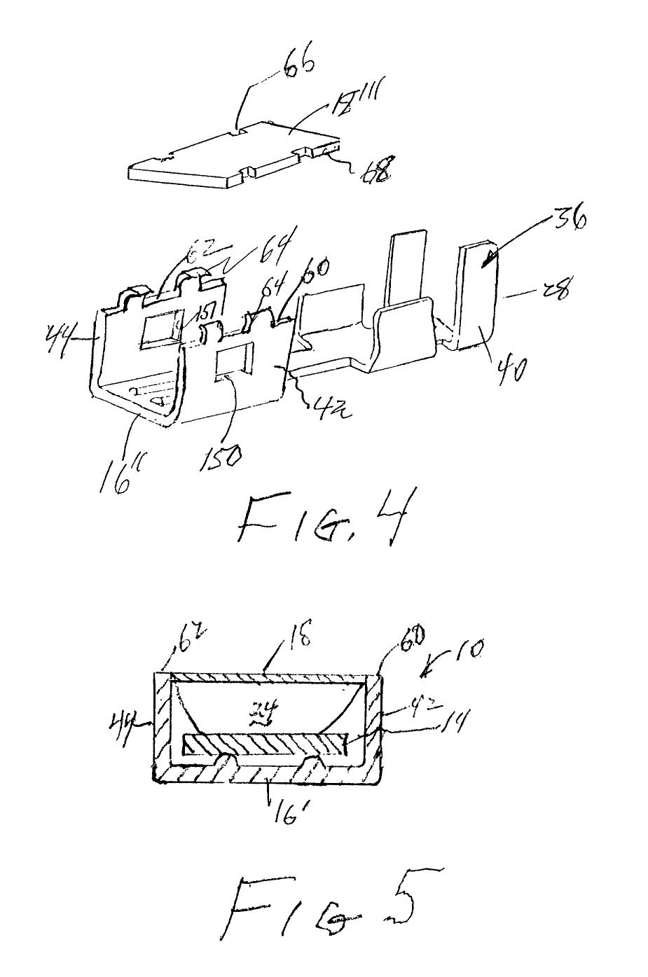

Referring to FIG. 4 there is shown a further embodiment of the invention in which the lateral sides 42 and 44 of the front part 12 comprise windows 150 and 151 for receiving the tabs 46 of the spring element 24. In such embodiment the spring 24 is inserted in the windows 150 and 151 either by force fitting or during a manufacturing step where the side walls are not totally bent perpendicular to the base 26. According to this embodiment of the contact 10 according to the invention, closing of the box shaped terminal is also done with cover 18 thus keeping with the two part structure of the invention.

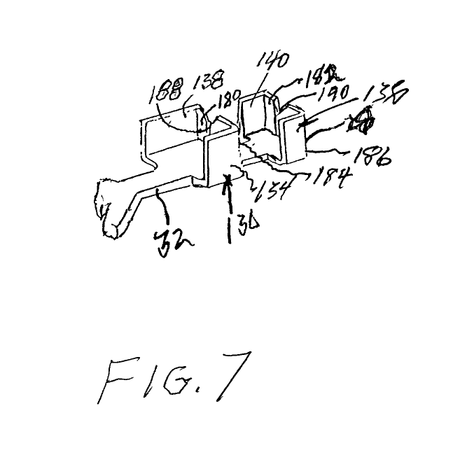

In a first realization mode as seen in FIG. 4, the cover 18 may comprise slots 66 which receive flaps 64 from walls 42 and 44. Flaps 64 are bent on cover 18 in order to mechanically lock the cover 18 on the base 16. In a second realization mode as seen in FIG. 1, the cover 18 is of a width allowing it to be received between side walls 42 and 44. Welding sports 58 link the side walls 42 and 44 and the cover 18 together. As seen in FIG. 6 an alternate design provides for the cover to rest on the edges of the side walls 42 and 44 and again the cover is secured to the side walls, which may be done by a welding technique. Both these structures create a strong link between the base 16 and the cover 18 enhancing the stiffness of the box shaped socket part 12 of the terminal 10.

Yet a further embodiment of a ferrule portion 130 in accordance with this invention is shown in FIG. 7. The ferrule portion 130 is different from the previous embodiments in that the intermediate section 134 and the distal section 136 are of the insulation piercing type. Opposing blade tabs 180 or 182 extend transversely of the base member 116″ toward one another from the downstream edges 184 and 186 of the respective side tabs 138 and 140 to define respective gaps 188 and 190. In use the conductor (not shown) is pressed into the gaps 188 and 190. The gaps 188 and 190 are sufficiently small so that the insulation of the conductor is cut by the blade tabs 180 and 182 which intern engage the conductor to provide an electrical connection thereto. The side tabs 138 and 140 may if desired be compressed to clamp the conductor in place. This insulation displacement type ferrule 130 can be employed, if desired, with any of the terminal embodiments described heretofore.

A first advantage of the terminal 10 of the present invention over terminals such as disclosed in the prior art above, resides in a great simplification of the manufacturing process since the manufacturing process for the socket part 12 of the base 16 comprises only folding the lateral walls 42 and 44 once and then inserting the spring 24 in the open box socket part 12 which may then be closed by the cover 18. A second advantage is that the cover 18 may be of a light or less conductive material while the base 16 remains of high conductive material.

It should be understood that the above description is merely illustrative of the invention. Various alternatives and modifications can be devised by those skilled in the art without departing from this invention. Accordingly, the present invention is intended to embrace all such alternatives, modifications and variances which fall within the appended claims.

What is claimed is:

1. A modular female electrical terminal having a receptacle portion for receiving a male electrical terminal, said receptacle portion comprising:
a first module capable of interfacing with a desired male electrical terminal shape, said first module comprising a base member, said base member including at said receptacle portion side walls integral therewith extending toward a cover member;
a second module comprising said cover member, said cover member being secured to said base member in an overlying relationship and defining in cooperation with said base member a cavity suitable for receiving said desired male electrical terminal shape; and
means for biasing said male electrical terminal into electrical and frictional contact with said receptacle portion.

2. A female electrical terminal as in claim 1 wherein said base member extends longitudinally in a first insertion direction corresponding to the direction in which said male terminal in inserted into said female terminal and wherein said base member further includes a ferule portion for receiving a lead wire, said ferule portion being arranged downstream of said receptacle portion and being integrally connected thereto.

3. A female electrical terminal as in claim 1 wherein said base member forms with said cover member a box shaped receptacle portion.

4. A female electrical terminal as in claim 1 wherein said biasing means comprises a separate biasing member supported by said side walls of said base member.

5. A female electrical terminal as in claim 4 wherein said base member has slots in said side walls and wherein said biasing member is inserted into said slots.

6. A female electrical terminal as in claim 4 wherein said base member has windows in said side walls and wherein said biasing member is inserted into said windows.

7. A female electrical terminal as in claim 1 wherein said cover member and said base member are secured together by mechanical locking means.

8. A female electrical terminal as in claim 1 wherein said cover member and said base member are secured together by a welded connection.

9. A female electrical terminal as in claim 8 wherein said welded connection comprises a laser welded connection.

10. A female electrical terminal as in claim 2 wherein said base member includes a plurality of separated contact ridges extending in said insertion direction.

11. A female electrical terminal as in claim 1 wherein said second thickness is less than said first thickness,

12. A female electrical terminal as in claim 1 wherein said first material has a higher conductivity than said second material.

13. A female electrical terminal as in claim 11 wherein said first material a higher conductivity than said second material.
